(19) United States
(12) Patent Application Publication
(10) Pub. No.: US 2008/0002606 A1
(43) Pub. Date: Jan. 3, 2008

(54) Identification of wireless devices based on signal characteristics

(76) Inventors: David Cheung, Santa Clara, CA (US); David Bormann, San Jose, CA (US); Scott Ettinger, Mountain View, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/479,104

(22) Filed: Jun. 30, 2006

(51) Int. Cl. H04Q 7/00

(52) U.S. Cl. 370/328

(57) ABSTRACT

A method and apparatus for identification of wireless devices based on signal characteristics. An embodiment of a method includes receiving a signal from a wireless device and generating a spectrogram of the received signal. The method further provides for identifying one or more regions of the spectrogram and processing the spectrogram to determine time, bandwidth, and density characteristics of the identified regions.

### FIELD

An embodiment of the invention relates to wireless communications in general, and more specifically to identification of wireless devices based on signal characteristics.

### BACKGROUND

The use of wireless devices has increased very rapidly, with many different types of devices having been introduced into the market. A computer system may encounter numerous devices using Wi-Fi (IEEE 802.11, referring to wireless fidelity), Bluetooth, or any other similar technology. The wide variety of wireless devices and signal types can in itself create some confusion. However, in addition there are many other devices that create radio signals as a byproduct of operation, and the combination of desirable and undesirable signals can lead to a great deal of signal interference.

In order to address multiple signals that are received it is useful to identify each of the various signals. Identification may in some circumstances be accomplished in the time domain. If the signals encountered in an environment are relatively few in number and have with low channel occupancy, such that the signals do not typically overlap in time, a conventional time domain solution that identifies time signatures may provide some assistance in identifying the relevant devices.

However, if an environment includes numerous coexisting devices that are broadcasting various different types of radio signals, then the received signals will often overlap in time. In such an environment, a conventional time signature approach to signal identification will be less useful because the signal interference may make the time signatures of the signals unrecognizable.

### BRIEF DESCRIPTION OF THE DRAWINGS

The invention may be best understood by referring to the following description and accompanying drawings that are used to illustrate embodiments of the invention. In the drawings:

FIG. 1 is an illustration of wireless devices in an environment to be identified using an embodiment of the invention;

FIG. 2 is an illustration of a satellite communication system using an embodiment of the invention;

FIG. 3 is an illustration of a microwave oven signal in time domain;

FIG. 4 is an illustration of a spectrogram of a microwave oven signal to be identified in an embodiment of the invention;

FIG. 5 is an illustration of multiple wireless signals in a time domain representation;

FIG. 6 is an illustration of a spectrogram of multiple wireless signals to be identified in an embodiment of the invention;

FIG. 7 is an illustration of a received signal with connected regions in an embodiment of the invention;

FIG. 8 is a flowchart illustrating an embodiment of identification of wireless devices;

FIG. 9 is a flowchart to illustrate an embodiment of wireless device identification to mitigate an extraneous signal;

FIG. 10 is an illustration of an embodiment of a wireless device identifier; and

FIG. 11 is an illustration of a computer system for an embodiment of the invention.

### DETAILED DESCRIPTION

A method and apparatus are described for identification of wireless devices based on signal characteristics.

As used herein, “wireless device” means any device that produces or receives a radio signal. As used herein, wireless devices include devices that produces an electromagnetic signal unintentionally, as well as devices that produce signals intentionally. For example, a microwave oven may be considered a wireless device for purposes of interference. Wireless devices may include, but are not limited to, Wi-Fi devices operating in accordance with the IEEE 802.11 standards, including IEEE 802.11a-1999, 802.11b-1999, and 802.11g-2003; Bluetooth devices operation in accordance with the IEEE 802.15.1-2002 standard; WiMAX (worldwide interoperability for microwave access) devices operation in accordance with IEEE 802.16-20041 or 802.16-2005; and UWB (ultra wideband) devices.

As used herein, “spectrogram” is generally a graphical representation of a frequency spectrum. A spectrogram may represent a short time Fourier transform (STFT) of a window of data, with, for example, a graph including an axis to represent time, an axis to represent frequency, and an intensity or brightness to represent power level.

In an embodiment of the invention, a wireless device is identified based on time and bandwidth occupancy and spectrogram density. In an embodiment, these characteristics form a signal's “signature”, which may be correlated with signatures of known wireless devices to identify the devices that are present. In an embodiment of the invention, the signal characteristics of known devices are identified to form a database of known signal signatures. In a particular embodiment, a signal signature represents a time-bandwidth-density signature that represents the time period, bandwidth, and power density of a spectrogram region.

A simple conventional method of wireless device identification is the characterization of signals purely in the time domain, thereby generating a time signature for each type of wireless device. If there is a relatively small set of wireless devices and low channel occupancy (so that signals do not typically overlap in time) in a particular environment, these time signatures may provide an acceptable process for identifying wireless devices. For example, time signature features that may be used for identification include the SIFS (Short Interframe Space) time between an IEEE 802.11a data packet and the resulting acknowledgment (ACK); the time alignment to 625 μs slots for Bluetooth transmission; and the common 16 ms time period, 50% duty cycle of a microwave oven.

However, in an environment such as a business office where many wireless devices co-exist, signals will often overlap in time, making the simple time signature approach less effective. The overlapping signals can make the time signatures of the individual signals very difficult to detect and separate from other signals.

In an embodiment of the invention, a joint time-frequency domain process, or spectrogram, is utilized to identify various wireless devices in an environment. In an embodiment of the invention, the signal regions that are generated in a spectrogram are characterized and used to identify the wireless devices in the environment. For example, the characteristics of certain known wireless device signals may be characterized to generate time-frequency-density signatures for each such device, with the signatures for each such signal being stored in a database. Unknown signals may be compared against the known time-frequency signatures to identify the wireless devices present in the environment. Upon identifying such devices, a system can address the devices as appropriate, which may include eliminating certain interfering signals.

In an embodiment of the invention, a time-frequency domain process is used to provide a more robust signal identification tool than a purely time domain approach. When signals overlap in time, the time signatures of the devices present are garbled. However, in the joint time-frequency domain, device characteristics may remain recognizable even in a busy environment.

In an embodiment of the invention, the data required from a spectrogram is reduced for faster processing and simplicity in implementation. Rather than addressing an entire spectrogram, an embodiment uses only time, bandwidth, and density to identify signals of wireless devices. These characteristics are relatively easy to extract from the spectrogram and do not require excessive memory to store, thus providing effective signature generation and signal identification. In an embodiment of the invention, the data required is limited to opposing corners of a rectangular area, which provide time and bandwidth limitations, and the number of pixels in the area, representing power levels.

For example, the time/bandwidth/density signatures for common wireless devices may include:

TABLE 1
Wi-Fi (IEEE 802.11a/b/g)

| | |
|---|---|
| Bandwidth | ~18 MHz |
| Time | >25 μs long |
| Density | High |
| Pattern | Often coming in pairs (data |
| | followed by ACK 10 μs or |
| | 16 μs later) |

TABLE 2
Bluetooth

| | |
|---|---|
| Bandwidth | <1 MHz |
| Time | Typically <625 us long |
| Density | High |
| Pattern | Characterized by neighboring |
| | hops on different frequencies, |
| | time aligned to 625 us slots if |
| | in same piconet (network of |
| | devices using Bluetooth |
| | technology) |

TABLE 3
Microwave Oven

| | |
|---|---|
| Bandwidth | >20 MHz |
| Time | 8.4 ms long (16.7 ms period |
| | with 50% duty cycle) |
| Density | Very Low |
| Pattern | Repeating |

In an embodiment of the invention, a system includes the following modules:

(1) Signal Processor—Converts a stream of input data, which may generally represent time domain samples containing energy from various wireless devices, into appropriately sized blocks for a fast Fourier transform.

(2) Spectrogram or STFT (Short Time Fourier Transform)—The data is transformed into a spectrogram, whereby, for example, the x-axis denotes time, the y-axis denotes frequency, and intensity indicates signal power level.

(3) Characteristic Extractor—Extracts time, bandwidth, and density characteristics from the spectrogram.

(4) Wireless Device Identifier—Identifies wireless devices in the relevant environment based on time-bandwidth-density signature.

In an embodiment of the invention, a characteristic extractor module may include the following components:

(a) Noise Reducer—This component may be used to reduce noise below a threshold. For example, the noise reducer may eliminate data below a certain power level to help reduce noise and spurious signals. In one embodiment, a threshold for an image is determined statistically based on the image intensity, such as according to a function of the mean and standard deviation of image intensity.

(b) Image Processor—The image processor may be used to remove extraneous elements from the images. In one example, the image processor may operate to “open” the image. Opening the image is an image processing technique to eliminate spurious regions of the spectrogram while still maintaining the overall size and shape of the stronger signals. The opening process generally consists of two basic morphological operations: an erosion operation followed by a dilation operation. With erosion, each output pixel of a region takes the value of the minimum pixel in its vicinity. The erosion operation has the effect of “eating away” at the regions in an image such that small regions disappear completely. The dilation operation then restores the original size of the stronger regions, with each output pixel taking the value of the maximum pixel in its vicinity.

(c) Low-Pass Filter—In an embodiment of the invention, a low-pass filter may be used to join together regions that were separated during by opening or other processing of the spectrogram image. For example, low-pass filtering along the time axis of an image, a one-dimensional filtering operation, may assist in joining together regions of weaker signals that were separated during an opening operation. To effectively process an image, the low-pass filter smoothes the image sufficiently to join regions that are separated by, for example, a few pixels, but does not join regions that are genuinely separated in time (for example, a data packet that is followed closely by an ACK packet).

(d) Region processor—In an embodiment of the invention, a region processor acts to connect and identify regions of an image. Regions of contiguous pixels are identified, with the rectangular bounds (such as the upper left and bottom right corners) and the number of pixels in each region being calculated. The region boundaries provide an approximate bandwidth and time occupancy estimate of each signal present. The number of pixels in each region divided by the area of the rectangular region indicates signal density. A list of these characteristics is output as the time-bandwidth-density signature of the wireless device.

In an embodiment of the invention, a wireless device identifier module for a system may include the following components:

(a) Characteristic Processor—The boundaries of each region provide an approximate bandwidth and time occupancy estimate of each signal present. This information, together with signal density, is utilized to provide an estimate of the wireless devices existing in the environment. As more characteristic signal regions are analyzed, the confidence in the estimate will increase.

(b) Device Identification—Given the analysis of the characteristic processor for the regions identified by the characteristic estimator, the wireless devices that are present in the environment are identified.

In an embodiment of the invention, a simple and effective process for extracting time, bandwidth, and density characteristics from a spectrogram is provided. Alternative methods for extracting this information might involve nested loops to first comb through the signal in time to identify pulses and then to sweep across frequency to check for time-overlapped pulses. However, without effective processing, the output of such a search would not be sufficiently clean, with many spurious or undesired signals being identified along with the signals of interest.

Certain wireless devices may regularly cause interference. If the signatures of such devices can be identified, the effect of such devices may be mitigated. In a particular example, microwave ovens currently reduce performance in wireless systems and make it difficult to identify wireless devices in spectrum sensing applications. Conventional device are generally not capable of mitigating the effect of microwave ovens, and most devices are not even aware of the presence of such an interferer. It may be possible to avoid the effects of microwave oven signals by avoiding the frequencies occupied by the microwave oven, or by attempting to synchronize transmissions to the 8 ms quiet period of the oven. However, both of these techniques result in reduced time and frequency availability, which will degrade network performance. In an embodiment of the invention, a device seeks to mitigate rather than avoid the microwave oven signal. The periodic nature of the microwave oven signal may be used to assist in mitigating of the effect of the microwave oven. In an embodiment, processing may proceed as follows:

Data input—The data may consist of time domain samples containing energy from various wireless devices. In this example, the wireless devices include a microwave oven, for which the signal signature is known.

Signal processing—The stream of input data is converted into appropriately sized blocks for Fourier transform.

STFT (Short Time Fourier Transform, or spectrogram)—The data is transformed into a spectrogram image, with the x-axis representing time, the y-axis representing frequency, and the intensity representing power level.

Signature identification—The signature of a microwave oven is known to include a time period of 16.7 ms frames, with a 50% duty cycle, and a bandwidth over 20 MHz. The signature is known to repeat regularly. Because of these known characteristics, it is possible to average over numerous 16.7 ms frames of the received signal to characterize the microwave oven signal. In this process, signals from other wireless devices will average out like noise.

Signal Mitigation—For signal mitigation, the microwave oven signature may be removed from received data. The microwave oven characterization may be subtracted from spectrograms that are either previously received or received in the near future to mitigate the effect of the microwave oven.

While the described process uses the particular example of a microwave oven, the process is not limited to this type of device. The effects of other types of wireless devices may also be addressed in this manner. For example, any wireless device with a known signature that is consistent and that repeats at known intervals may be removed from received signals. In addition, applications of the described process are not limited to removal of a signal for this particular purpose, but rather may also be used in other circumstances as well. For example, in certain embodiments this technique may be utilized to improve wireless data communication by removing (subtracting) an estimate of an interfering signal from a received data signal, and thus to provide a better estimate of the remaining signal of interest.

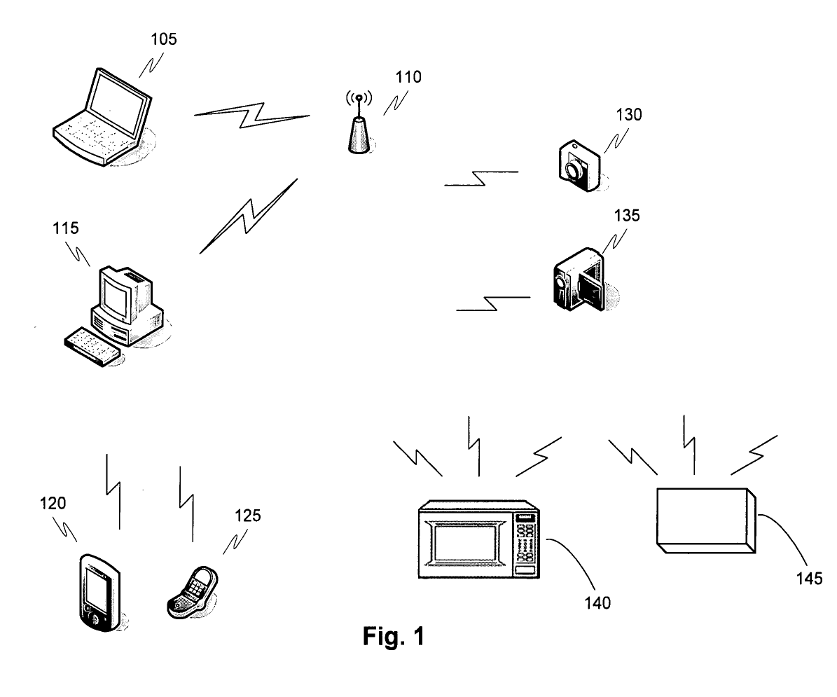

FIG. 1 is an illustration of wireless devices in an environment to be identified using an embodiment of the invention. In this illustration, a laptop computer 105 and a desktop computer 115 may both be communicating with, for example, a Wi-Fi (IEEE 802.11) or WiMAX (IEEE 802.16) access point 110. However, the computers may also be receiving Bluetooth or other similar signals from a personal data assistant (PDA) device 120 and a cell phone 125. Further, in close proximity one or more audio-visual devices, such as a digital camera 130 or a digital video recorder 135, may provide content to a computer or other device using, for example, ultra wideband (UWB) signals. Further, additional devices may create incidental signals as part of operations that escape signal shielding. For example, a microwave oven 140 will produce signals, and certain other unknown devices 145 may produce additional signals. In an embodiment of the invention, the signals of the various devices are identified using time, bandwidth, and intensity signal signatures, allowing receiving devices to recognize the devices and address them appropriately.

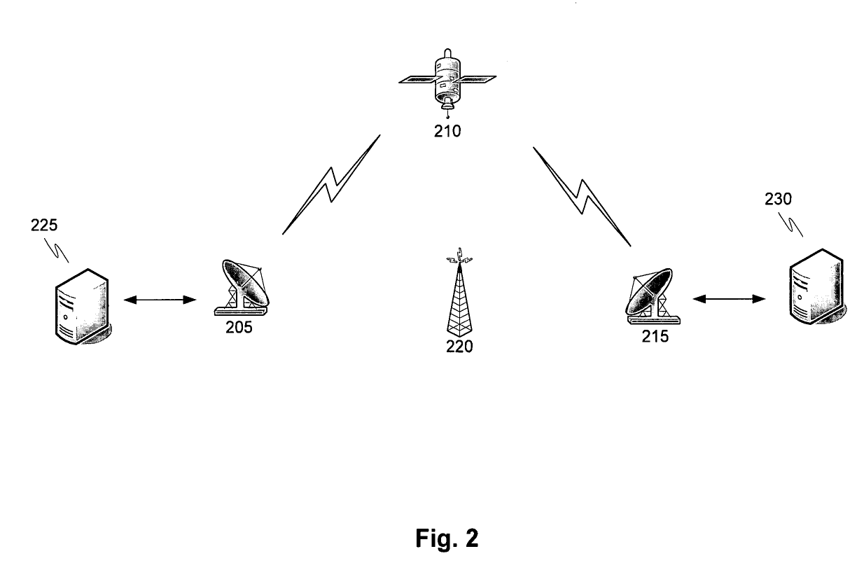

FIG. 2 is an illustration of a satellite communication system using an embodiment of the invention. In this illustration, a first computer 225 or other device may communicate with a second computer 230 or other device via a satellite connection. For example, the first computer 225 may provide a signal to a first communication dish 205, which broadcasts an uplink signal to a satellite 210. The satellite 210 then may transmit the signal via a downlink signal received by a second communication dish 215 and on to the second computer 230. However, signal interference can result from various sources, including, for example, a terrestrial antenna 220 or other device. In an embodiment of the invention, the various signals are identified via time, bandwidth, and intensity signal signatures.

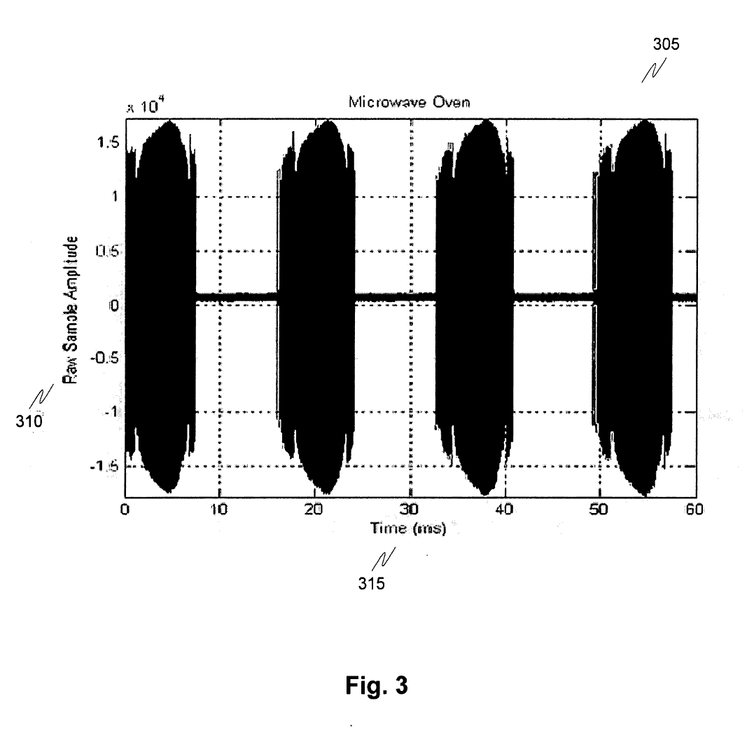

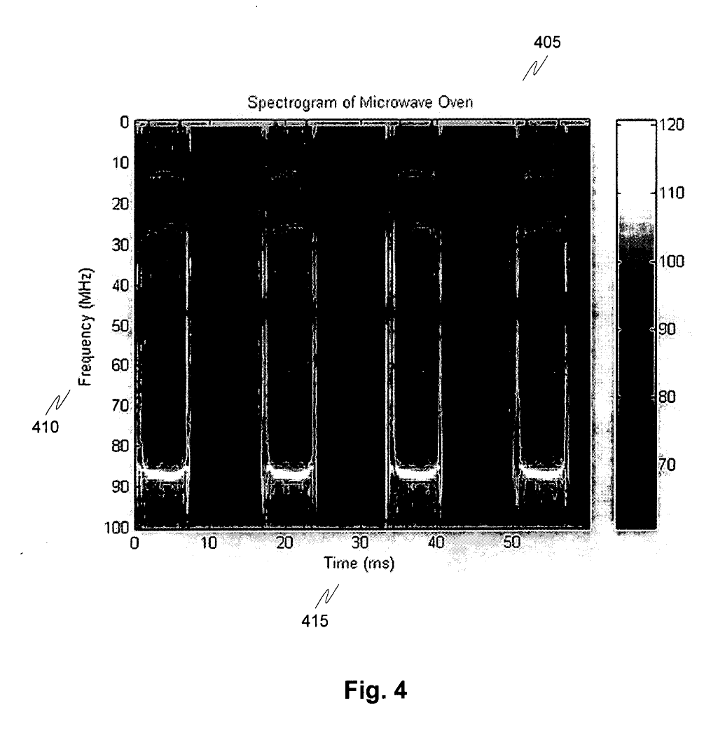

FIG. 3 is an illustration of a microwave oven signal in time domain. The microwave oven can cause significant interference. As illustrated, the image 305 is provided in terms of time 315 and amplitude 310. While the signal illustration provides a potential time signature, it may not provide identifiable information if other signals intrude into the same time period. In contrast, FIG. 4 is an illustration of a spectrogram of a microwave oven signal to be identified in an embodiment of the invention. As illustrated, the spectrogram 405 provides an illustration of time 415 versus frequency 410, with the brightness of the image reflecting the power level. Thus, an image is generated that provides a signal outline that reflects the signal intensity in the time-frequency domain.

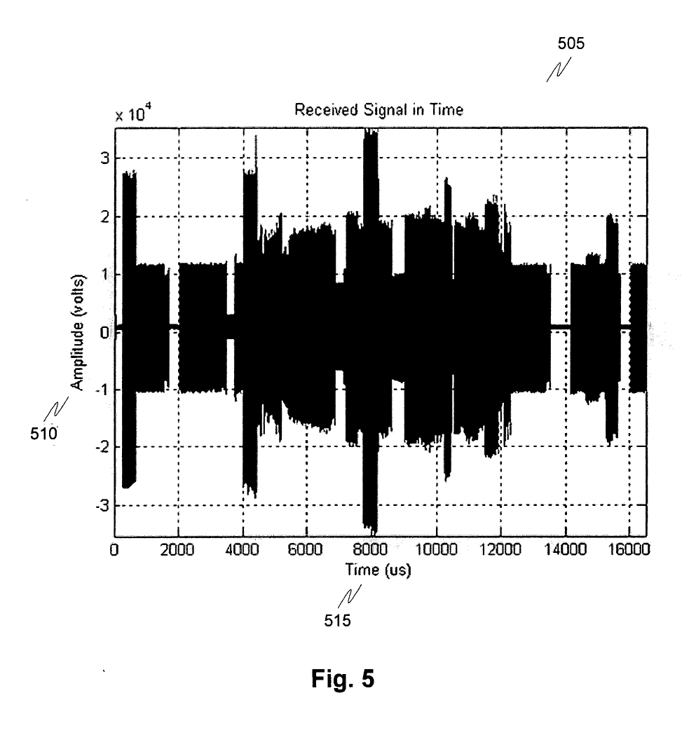

FIG. 5 is an illustration of multiple wireless signals in a time domain representation. FIG. 5 illustrates the difficulty of identifying and dealing with multiple overlapping signals in pure time domain. In this illustration, the image 505 is shown in terms of time 515 and amplitude 510. However, the received signals are the result of multiple wireless devices providing signals in an overlapping fashion. The signals may include both intentionally broadcast signals and incidental signals created by other devices. Identification of the signals by time signatures may be very difficult because of overlap of the various signals. In an embodiment of the invention, the signals are transferred to a time-frequency domain format for identification.

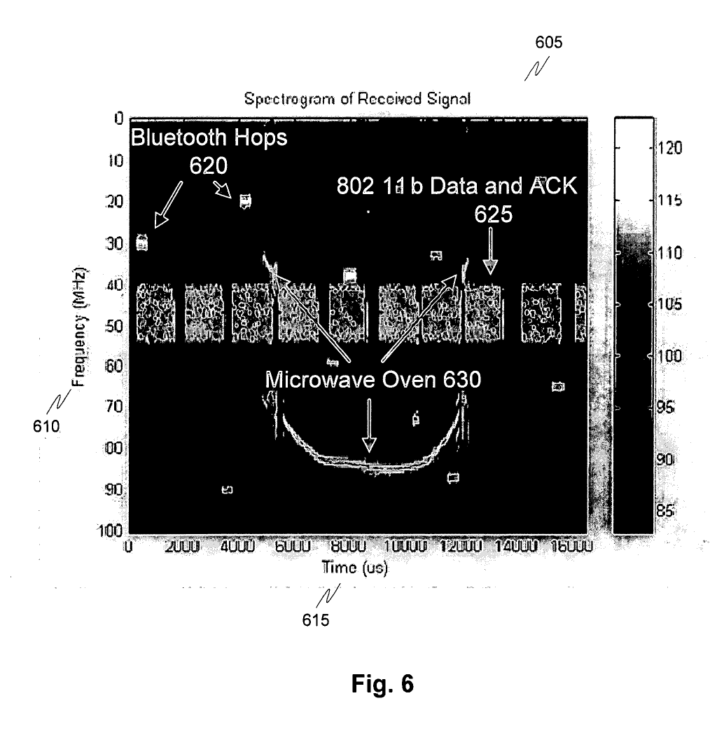

FIG. 6 is an illustration of a spectrogram of multiple wireless signals to be identified in an embodiment of the invention. FIG. 6 illustrates the signals that were present in FIG. 5, but in an alternative format that allows effective signal identification. The image 605 is provided in the time-frequency domain, with time 615 being provided on the x-axis, frequency 610 being provided on the y-axis, and the power level being represented by the brightness of the image 605. The illustrated signals include Bluetooth signals, as identified by the distinctive Bluetooth signal hops 620; an 802.11b data and acknowledgement 625, and a microwave oven 630. In an embodiment of the invention, a time-bandwidth-density signature in may be generated for each such signal that efficiently captures the distinctive signal characteristics.

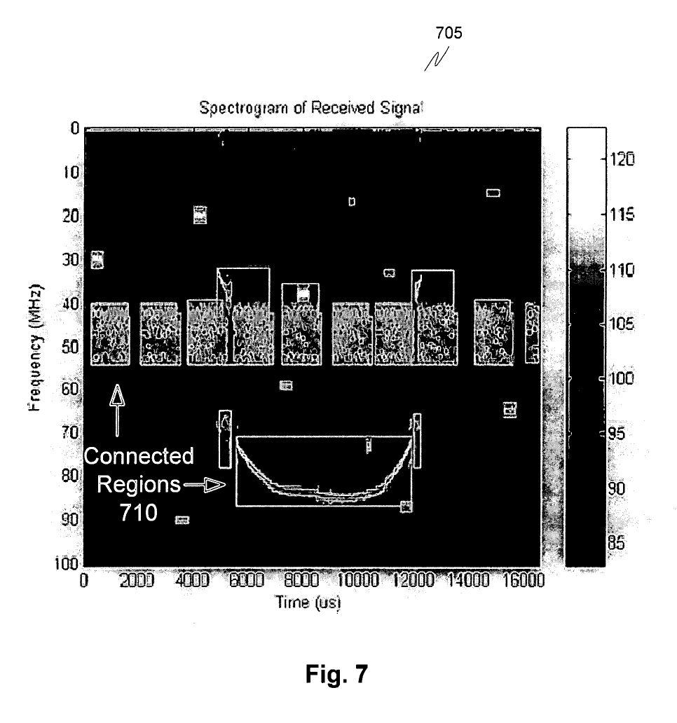

FIG. 7 is an illustration of a received signal with connected regions in an embodiment of the invention. In this illustration, the spectrogram shown in FIG. 6 has been processed using video techniques to connect signal regions. In this manner, the signal characteristics can be emphasized for identification in an embodiment of the invention. In an embodiment of the invention, the characteristics of the resulting identified regions may be compared against the signatures for known wireless devices to identify the wireless devices in the environment.

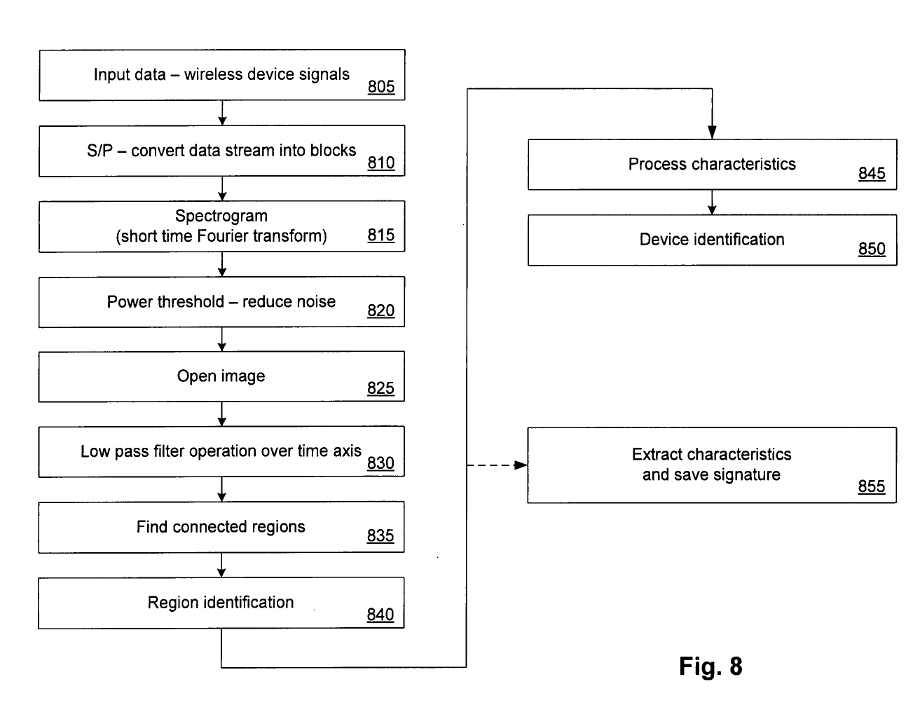

FIG. 8 is a flowchart illustrating an embodiment of wireless device identification. In this embodiment, wireless device signal data is input 805 as a data stream, with it being assumed that some or all of the signals being received are of unknown origin. Signal processing is implemented to convert the data stream into blocks 810. A short time Fourier transform is implemented 815, which creates a spectrogram image of the signal characteristics. Signals below a certain power threshold are removed to reduce extraneous signals and noise 820. The power threshold may, for example, be determined by a statistical function of the mean and standard deviation of the image intensity. The image is then processed to remove extraneous noise and signals, which may include opening the image 825, the process of opening including an erosion operation followed by a dilation operation. A low-pass filter operation 830 may be performed to join together regions of weaker signals that were separated during the opening operation, the filter operation being a one-dimensional low pass filter over the time axis. Connected regions are found 835 and the resulting regions are identified 840. If the received signal is a known wireless device, the time-bandwidth-density characteristics may be extracted from the image and saved as the signature for the wireless device 855 for future identifications. If the device is an unknown device, the characteristics are then processed 845 to estimate the wireless devices present in the environment. The identification process may include comparison with signatures of known wireless devices. When sufficient confidence has been reached, the wireless devices are identified 850.

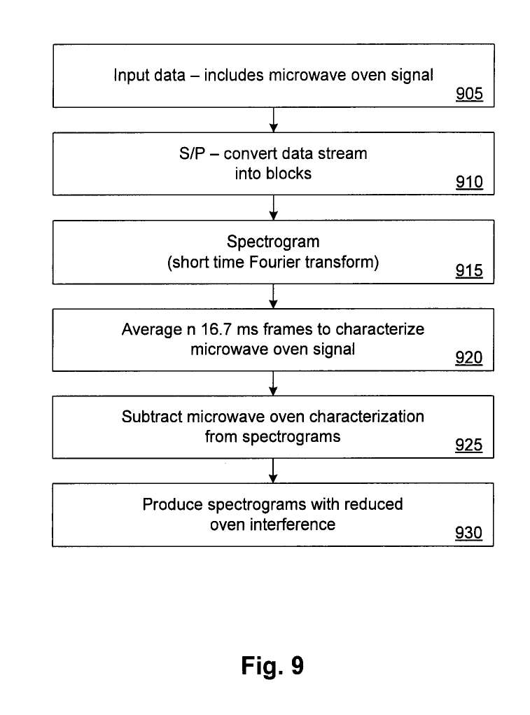

FIG. 9 is a flowchart to illustrate an embodiment of wireless device identification to mitigate an extraneous signal. In this illustration, the particular example of a microwave oven is addressed. An input data stream is received 905, with the data including an interfering signal from a microwave oven that is present in the environment. The data stream is converted into blocks for processing 910 and spectrogram is generated for a block of data 915. Because of the regular and known signature pattern of a microwave oven, a number n of 16.7 ms frames may be averaged to characterize the time-bandwidth-density of a microwave signal 920, which results in other signals dropping out. The resulting microwave over characterization may be subtracted from spectrograms 925. The result is spectrograms with reduced microwave oven interference 930, which may be further processed to identify other wireless device signals present in the environment.

FIG. 9 provides a specific example regarding the mitigation of microwave interference for the purpose of identifying wireless devices, thus operating to clean up a spectrogram for analysis. However, applications of this embodiment of the invention are not limited to this particular purpose. For example, it may also be possible to apply this technique to improve wireless data communication by removing (subtracting) an estimate of an interfering signal from a received data signal and thus provide a better estimate of the remaining signal of interest.

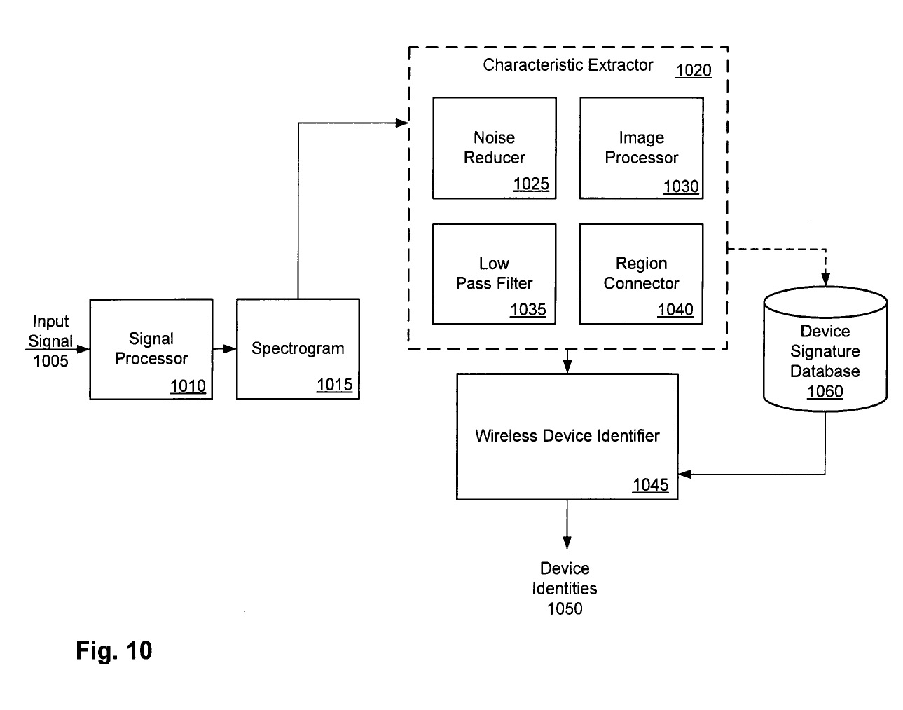

FIG. 10 is an illustration of an embodiment of a wireless device signal processor. In this illustration, a signal input 1005 is received, the signal input representing samples of signals received from one or more wireless devices. The signal input 1005 is received by a signal processor 1010 that divides the data stream into blocks of data for processing. The data blocks are be provided to a spectrogram component 1015, which will produce time-frequency domain images of the signal input. In an embodiment, the resulting spectrogram images are provided to a characteristic extractor 1020, which is intended to determine time, bandwidth, and density characteristics for the signal input. The determination may be made to provide an identification of an unknown device or to generate a signature for a known wireless device for future device identifications. For a known device the signature may, for example, be stored in a database 1060. For an unknown device, the characteristics of the signal are provided to a wireless device identifier module 1045, which will identify the wireless devices present in the environment. The identification may include comparison of the signal characteristics to signatures of known wireless devices, which may, for example, be stored in the database 1060. The wireless device identifier module 1045 provides an output of the device identities 1050.

The characteristic extractor 1020 may include a noise reduction component 1025 to reduce noise below a threshold, eliminating data below a certain power level to help reduce noise and spurious signals. The characteristic extractor 1020 may further include an image processor 1030 to process the image. The image processing may include opening the image to eliminate spurious regions of the spectrogram while still maintaining the overall size and shape of the stronger signals. The characteristic extractor 1020 may also include a low-pass filter 1035 to join together regions that were separated during by opening or other processing of the spectrogram image and a region connector 1040 to connect and identify regions of an image, thereby resulting in time-bandwidth-density characteristics for the input signal.

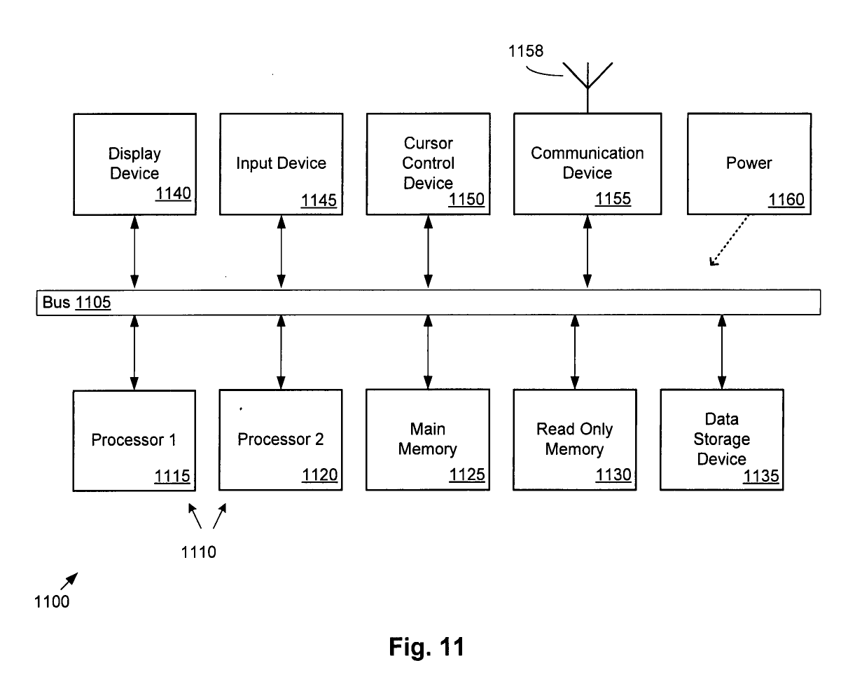

FIG. 11 is an illustration of a computer system for an embodiment of the invention. Certain standard and well-known components that are not germane to the present invention are not shown. Under an embodiment of the invention, a computer 1100 comprises a bus 1105 or other communication means for communicating information, and a processing means such as two or more processors 1110 (shown as a first processor 1115 and a second processor 1120) coupled with the bus 1105 for processing information. The processors 1110 may comprise one or more physical processors and one or more logical processors. Further, each of the processors 1110 may include multiple processor cores. The computer 1100 is illustrated with a single bus 1105 for simplicity, but the computer may have multiple different buses and the component connections to such buses may vary. The bus 1105 shown in FIG. 11 is an abstraction that represents any one or more separate physical buses, point-to-point connections, or both connected by appropriate bridges, adapters, or controllers. The bus 1105, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, sometimes referred to as “Firewire”. (“Standard for a High Performance Serial Bus” 1394-1995, IEEE, published Aug. 30, 1996, and supplements) In an embodiment of the invention, the processors 1110 may be used to analyze and identify signals received from wireless devices.

The computer 1100 further comprises a random access memory (RAM) or other dynamic storage device as a main memory 1125 for storing information and instructions to be executed by the processors 1110. Main memory 1125 also may be used for storing temporary variables or other intermediate information during execution of instructions by the processors 1110. RAM memory includes dynamic random access memory (DRAM), which requires refreshing of memory contents, and static random access memory (SRAM), which does not require refreshing contents, but at increased cost. DRAM memory may include synchronous dynamic random access memory (SDRAM), which includes a clock signal to control signals, and extended data-out dynamic random access memory (EDO DRAM). The uses of the main memory may include the storage received signals from wireless devices. The computer 1100 also may comprise a read only memory (ROM) 1130 and/or other static storage device for storing static information and instructions for the processors 1110.

A data storage device 1135 may also be coupled to the bus 1105 of the computer 1100 for storing information and instructions. The data storage device 1135 may include a magnetic disk or optical disc and its corresponding drive, flash memory or other nonvolatile memory, or other memory device. Such elements may be combined together or may be separate components, and utilize parts of other elements of the computer 1100.

The computer 1100 may also be coupled via the bus 1 105 to a display device 1140, such as a cathode ray tube (CRT) display, a liquid crystal display (LCD), a plasma display, or any other display technology, for displaying information to an end user. In some environments, the display device may be a touch-screen that is also utilized as at least a part of an input device. In some environments, display device 1140 may be or may include an audio device, such as a speaker for providing audio information. An input device 1145 may be coupled to the bus 1105 for communicating information and/or command selections to the processors 1110. In various implementations, input device 1145 may be a keyboard, a keypad, a touch-screen and stylus, a voice-activated system, or other input device, or combinations of such devices. Another type of user input device that may be included is a cursor control device 1150, such as a mouse, a trackball, or cursor direction keys for communicating direction information and command selections to the one or more processors 1110 and for controlling cursor movement on the display device 1140.

A communication device 1155 may also be coupled to the bus 1105. Depending upon the particular implementation, the communication device 1155 may include a transceiver, a wireless modem, a network interface card, LAN (Local Area Network) on motherboard, or other interface device. The uses of a communication device 1155 may include reception of signals from wireless devices. For radio communications, the communication device 1155 may include one or more antennas 1158. In one embodiment, the communication device 1155 may include a firewall to protect the computer 1100 from improper access. The computer 1100 may be linked to a network or to other devices using the communication device 1155, which may include links to the Internet, a local area network, or another environment. The computer 1100 may also comprise a power device or system 1160, which may comprise a power supply, a battery, a solar cell, a fuel cell, or other system or device for providing or generating power. The power provided by the power device or system 1160 may be distributed as required to elements of the computer 1100.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention may include various processes. The processes of the present invention may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

Portions of the present invention may be provided as a computer program product, which may include a machine-readable medium having stored thereon instructions, which may be used to program a computer (or other electronic devices) to perform a process according to the present invention. The machine-readable medium may include, but is not limited to, floppy diskettes, optical disks, CD-ROMs (compact disk read-only memory), and magneto-optical disks, ROMs (read-only memory), RAMs (random access memory), EPROMs (erasable programmable read-only memory), EEPROMs (electrically-erasable programmable read-only memory), magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the present invention is not to be determined by the specific examples provided above but only by the claims below.

It should also be appreciated that reference throughout this specification to “one embodiment” or “an embodiment” means that a particular feature may be included in the practice of the invention. Similarly, it should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

What is claimed is:

1. A method comprising:
receiving a signal from a wireless device;
generating a spectrogram of the signal;
identifying one or more regions of the spectrogram; and
processing the spectrogram to determine time, bandwidth, and density characteristics of the identified regions.

2. The method of claim 1, further comprising identifying the wireless device based at least in part on the determined characteristics of the identified regions.

3. The method of claim 2, wherein identifying the wireless device includes comparing the characteristics to a signature of a known wireless device.

4. The method of claim 1, further comprising saying the determined characteristics as a signature of the wireless device.

5. The method of claim 1, wherein generating a spectrogram comprises converting a data stream for the wireless signal in to a plurality of blocks for analysis.

6. The method of claim 1, wherein processing the spectrogram comprises removing noise from the spectrogram.

7. The method of claim 1, wherein processing the spectrogram comprises opening the spectrogram signal.

8. The method of claim 7, wherein opening the spectrogram includes an erosion operation and a dilation operation.

9. A wireless device signal processor comprising:
a signal input to receive signal data for one or more wireless devices;
a spectrogram module to produce a spectrogram image of the received signal data; and
a characteristic extractor module to extract time, frequency, and density characteristics of the spectrogram image.

10. The signal processor of claim 9, further comprising a wireless device identification module to identify the one or more wireless devices based at least in part on the time, frequency, and density characteristics.

11. The signal processor of claim 10, wherein the wireless device identification module identifies one or more wireless devices by comparing the characteristics to signatures of known wireless devices.

12. The signal processor of claim 9, further comprising a module to divide a data stream representing the signal data into a plurality of blocks for the first module.

13. The signal processor of claim 9, wherein the characteristic extractor module comprises a noise reducer component to reduce noise in the spectrogram.

14. The signal processor of claim 9, wherein the characteristic extractor module comprises an image processor component to open the spectrogram image.

15. The signal processor of claim 14, wherein the image processor component opens the spectrogram image by performing an erosion operation on the image and performing a dilation operation on the image.

16. The signal processor of claim 14, wherein the characteristic extractor module comprises a low pass filter to join together regions that were separated by the opening of the spectrogram image.

17. The signal processor of claim 9, wherein the image module comprises a region connector component to connect regions of the spectrogram for the signature for the received signal and extract time, bandwidth, and density characteristics of the regions.

18. A computer system comprising:
a communication device to receive wireless signals;
a synchronous dynamic random access memory (SDRAM) to hold wireless device signal data;
a processor to process the data stream, the processor to perform a short time Fourier transform (STFT) on the data to generate a spectrogram image; and
a characteristic extractor to extract time-frequency domain characteristics from the spectrogram image.

19. The computer system of claim 18, further comprising a database to store characteristics of one or more known wireless devices.

20. The computer system of claim 18, wherein the processor is to identify one or more wireless devices that generated the wireless signals.

21. The computer system of claim 18, wherein identification of the one or more wireless devices by the process includes comparing the extracted characteristics to characteristics of one or more known devices

22. A machine-readable medium having stored thereon data representing sequences of instructions that, when executed by a machine, cause the machine to perform operations comprising:
receiving signals from one or more wireless devices;
generating a spectrogram of the signals;
identifying one or more regions of the spectrogram;
processing the spectrogram to determine time, bandwidth, and density characteristics of the identified regions; and
identifying one or more wireless devices based at least in part on the determined characteristics of the identified regions.

23. The medium of claim 22, wherein identifying the wireless devices includes comparing the characteristics to signatures of one or more known wireless devices.

24. The medium of claim 22, wherein processing the spectrogram comprises removing noise from the spectrogram.

25. The medium of claim 22, wherein processing the spectrogram comprises opening the spectrogram signal.

26. The medium of claim 25, wherein opening the spectrogram includes an erosion operation and a dilation operation.
